(19) United States
(12) Patent Application Publication
(10) Pub. No.: US 2010/0045903 A1
(43) Pub. Date: Feb. 25, 2010

(54) LIQUID CRYSTAL DEVICE AND ELECTRONIC APPARATUS

(75) Inventors: Shuji ARUGA, Suwa (JP); Norio KOMA, Kitagata-cho (JP)

Correspondence Address: OLIFF & BERRIDGE, PLC, P.O. BOX 320850, ALEXANDRIA, VA, 22320-4850, US

(73) Assignee: Seiko Epson Corporation, Tokyo (JP)

(21) Appl. No.: 12/536,833

(22) Filed: Aug. 6, 2009

(30) Foreign Application Priority Data
Aug. 22, 2008 (JP) 2008-213639

(51) Int. Cl. G02F 1/1335

(52) U.S. Cl. 349/96; 349/114

(57) ABSTRACT

A liquid crystal device includes a plurality of pixels. Each of the plurality of pixels includes a liquid crystal layer interposed between first and second substrates facing each other and having liquid crystal molecules to be driven by an applied electric field, a first electrode formed on a side of the first substrate facing the second substrate, and a second electrode formed on a side of the first substrate facing the second substrate and interposing an insulating layer together with the first electrode. A reflective display area for reflective display and a transmissive display area for transmissive display are formed within each of the pixels. The liquid crystal molecules have a negative dielectric anisotropy.

### BACKGROUND

1. Technical Field

The present invention relates to a technical field of a liquid crystal device and an electronic apparatus including the liquid crystal device.

2. Related Art

There is a liquid crystal device in which liquid crystal as an electro-optic material is interposed between a pair of substrates. In the liquid crystal device, the liquid crystal is aligned in a predetermined aligned state between the pair of substrates, for example, and gray scales are displayed by applying a predetermined voltage to the liquid crystal in every pixel formed in an image display area to vary the alignment or order of the liquid crystal and by modulating light, for example.

As this liquid crystal device, there is known a transflective liquid crystal device in which a reflective display area and a transmissive display area are formed in one pixel (for example, see JP-A-2005-338264, JP-A-2006-171316, JP-A-2007-47734, and JP-A-2003-344837). The transflective liquid crystal device is known as a liquid crystal device that has both an advantage of a reflective liquid crystal device capable of achieving low power consumption, thinness, and light-weight since a backlight unit is not necessary and an advantage of a transmissive liquid crystal device capable of achieving excellent visibility even when ambient light is dark since a backlight unit is used as a light source.

On the other hand, as the liquid crystal device, there is known a liquid crystal device using a transverse electric field driving mode such as an IPS (In-Plane Switching) mode or an FFS (Fringe Field Switching) mode, in which pixel electrodes and a common electrode are formed in a TFT array substrate and the direction of an electric field applied to liquid crystal is substantially parallel to the substrates (for example, see JP-A-2005-338264, JP-A-2006-171316, JP-A-2007-47734, and JP-A-2003-344837). The transverse electric field driving mode has gained popularity, since the transverse electric field driving mode has better visible characteristics than a longitudinal electric field driving mode such as a TN (Twisted Nematic) driving mode in which a vertical electric field is applied to liquid crystal interposed between pixel electrodes and counter electrodes respectively formed in a pair of substrates facing each other.

Here, in the liquid crystal device using the transverse electric field driving mode, the horizontal electric field has to be originally generated in the direction substantially parallel to the substrates between the pixel electrodes and the common electrode formed on the TFT array substrate. However, a vertical electric field may be generated in a direction perpendicular to the substrates. In this case, the liquid crystal which has to be originally driven in the direction substantially parallel to the substrates (in other words, which has to rotate within a plane substantially parallel to the substrates) may be driven in the direction perpendicular to the substrates (in other words, erected in the direction perpendicular to the substrates). For this reason, the alignment of the liquid crystal is not controlled in the originally intended state thereof, thereby causing deterioration in the display quality of the liquid crystal device.

### SUMMARY

An advantage of some aspects of the invention is that it provides a transflective liquid crystal device using a transverse electric field driving mode, for example, which is capable of preventing a display quality from deteriorating and an electronic apparatus including the liquid crystal device.

### Liquid Crystal Device

According to an aspect of the invention, there is provided a liquid crystal device including a plurality of pixels. Each of the plurality of pixels includes a liquid crystal layer interposed between a first substrate (for example, a TFT array substrate described below) and a second substrate (for example, a counter substrate described below) facing each other and having liquid crystal molecules to be driven by an applied electric field, a first electrode (for example, a pixel electrode described below) formed on a side of the first substrate facing the second substrate, and a second electrode (for example, a common electrode described below) formed on a side of the first substrate facing the second substrate and interposing an insulating layer together with the first electrode. A reflective display area for reflective display and a transmissive display area for transmissive display are formed within each of the pixels. The liquid crystal molecules have a negative dielectric anisotropy.

In the liquid crystal device according to this aspect of the invention, the alignment state of the liquid crystal molecules interposed between the pair of substrates (that is, the first and second substrates) can be varied by an electric field generated due to a potential difference between the first and second electrodes. Therefore, the liquid crystal device can be used as various display devices such as a direct-view type device or a projection type device. According to this aspect of the invention, a horizontal electric field can be used as an example of the electric field. “The horizontal electric field” refers to an electric field (an electric field generated parallel or substantially parallel to the surface of the first or second substrate) generated in a direction oriented in a direction of the surface of the first or second substrate. In addition, according to this aspect of the invention, the insulating layer is formed between the first and second electrodes. That is, according to this aspect of the invention, the first electrode, the insulating layer, and the second electrode are formed on the first substrate so as to form a laminated structure in a normal line direction of the first or second substrate. In other words, the liquid crystal device according to this aspect of the invention uses a transverse electric field driving mode such as an FFS (Fringe Field Switching) mode.

According to this aspect of the invention, each of the pixels is provided with the transmissive display area for transmissive display and the reflective display area for reflective display. That is, the liquid crystal device according to this aspect of the invention is a transflective liquid crystal device. Therefore, since it is necessary for light incident from the first substrate to transmit through the liquid crystal layer and the second substrate in the transmissive display area and be viewed to an observer, for example, it is preferable that the first and second electrodes are each a transparent electrode in the transmissive display area. On the other hand, since it is necessary for light incident from the second substrate to transmit through the liquid crystal layer and then reflect and to again transmit through the liquid crystal layer and the second substrate and be viewed to the observer in the reflective display area, for example, it is preferable that at least one of the first and second electrodes in the reflective display area is an electrode containing a metal material or a reflective film is formed at a position facing at least one of the first and second electrodes in the reflective display area.

According to this aspect of the invention, the liquid crystal molecules contained in the liquid crystal layer have a negative dielectric anisotropy. In other words, the liquid crystal molecules contained in the liquid crystal layer include negative dielectric anisotropy type liquid crystal molecules or are configured as negative dielectric anisotropy type liquid crystal molecules.

Here, since the liquid crystal molecules have a negative dielectric anisotropy, the liquid crystal molecules rotate such that the major axis direction of the liquid crystal molecules is perpendicular to the direction of the electric field (in other words, so as to be oriented in the direction of the electric field applied in the minor axis direction of the liquid crystal molecules). Therefore, when the horizontal electric field as the electric field generated in the direction of the surface of the first or second substrate is applied, the liquid crystal molecules rotate in the plane parallel to the surface of the first or second substrate. On the other hand, even when a vertical electric field, which is an electric field (typically, an electric field perpendicular or substantially perpendicular to the surface of the first or second substrate) generated in a direction intersecting the surface of the first or second substrate, is unintentionally applied to the liquid crystal layer, the minor axis of the liquid crystal molecules is aligned in the direction of the vertical electric field (that is, the major axis direction of the liquid crystal molecules is aligned so as to be perpendicular to the vertical electric field). Therefore, the major axis direction of the liquid crystal molecules remains parallel to the surface of the first or second substrate. In order words, the liquid crystal molecules are not erected or do not rise up in a direction perpendicular to the surface of the first or second substrate. That is, not only when the horizontal electric field is originally applied to the liquid crystal layer but also when the vertical electric field is unintentionally applied to the liquid crystal layer, the major axis direction of the liquid crystal molecules is surely aligned parallel to the surface of the first or second substrate along the vertical electric field and the liquid crystal molecules rotate in the plane parallel to the surface of the first or second substrate along the horizontal electric field. With such a configuration, even when not only the horizontal electric field but also the vertical electric field is applied, the liquid crystal molecules rotate while the major axis direction remains substantially parallel to the surface of the first or second substrate. Accordingly, the drive of the liquid crystal molecules contained in the liquid crystal layer can be appropriately controlled. As a result, it is possible to appropriately prevent the display quality of the liquid crystal device from deteriorating.

In particular, in the liquid crystal device according to the above aspect of the invention, the transmissive display area and the reflective display area are formed in one pixel. Therefore, the vertical electric field may be unintentionally generated in the vicinity of the boundary between the transmissive display area and the reflective display area. For example, originally, an electric field generated in accordance with a potential difference between the first and second electrodes in the transmissive display area is applied to the liquid crystal layer in the transmissive display area, and an electric field generated in accordance with a potential difference between the first and second electrodes in the reflective display area is applied to the liquid crystal layer in the reflective display area. However, an electric field generated in accordance with a potential difference between the first electrode in the transmissive display area and the first or second electrode in the reflective display area or an electric field generated in accordance with a potential difference between the second electrode in the transmissive display area and the first or second electrode in the reflective display area may be applied to the liquid crystal layer. In this case, the electric field generated in accordance with a potential difference between the first electrode in the transmissive display area and the first or second electrode in the reflective display area, or the electric field generated in accordance with a potential difference between the second electrode in the transmissive display area and the first or second electrode in the reflective display area may become the vertical electric field with respect to the liquid crystal layer (or may have a component of the vertical electric field). However, even when this vertical electric field is generated, as described above, the liquid crystal molecules rotate such that the major axis direction thereof remains substantially parallel to the surface of the first or second substrate. Accordingly, even the transflective liquid crystal device can appropriately control the drive of the liquid crystal molecules contained in the liquid crystal layer. As a result, it is possible to appropriately prevent the display quality of the liquid crystal device from deteriorating.

The liquid crystal device according to the above aspect of the invention may further include a first polarizing plate which has a transmission axis oriented in a first direction (for example, a direction forming 45° in a plan view) and is formed on a side of the first substrate opposite to the second substrate; a second polarizing plate which has a transmission axis oriented in a direction (for example, a direction forming 135° in a plan view) perpendicular to the first direction and is formed on a side of the second substrate opposite to the first substrate; and alignment films which are respectively formed on the sides of the first and second substrates facing the liquid crystal layer and subjected to a rubbing process in the first direction or a direction (for example, the direction forming 135° in a plan view) perpendicular to the first direction. One of the first and second electrodes facing the liquid crystal layer has (i) a first slit extending in a direction (for example, a direction forming 0° in a plan view) forming 45° with respect to the first direction in the reflective display area and (ii) a second slit extending in a direction (for example, a direction forming 45° in a plan view) substantially perpendicular to a rubbing direction in the transmissive display area. Retardation of the liquid crystal layer in the reflective display area is a ¼ wavelength and retardation of the liquid crystal layer in the transmissive display area is a ½ wavelength.

According to the above aspect of the invention, the following operation is carried out in the reflective display area. First, when an electric field is applied to the liquid crystal layer in the reflective display area, the electric field is generated in the direction (for example, a direction forming 90° in a plan view) perpendicular to the longitudinal direction (for example, a direction forming 0° in a plan view) of the first slit. Therefore, the liquid crystal molecules of the liquid crystal layer in the reflective display area rotate such that the major axis direction thereof is oriented toward the longitudinal direction of the first slit. Accordingly, linearly-polarized light (for example, linearly-polarized light in a direction forming 135° in a plan view) which has transmitted through the second polarizing plate is set such that the retardation of the liquid crystal layer in the reflective display area is a ¼ wavelength. Therefore, when the linearly-polarized light transmits through the liquid crystal layer in the reflective display area, the linearly-polarized light becomes elliptically-polarized light rotating left (or elliptically-polarized light rotating right). Thereafter, when the elliptically-polarized light rotating left (or the elliptically-polarized light rotating right) reflects from the reflective layer or the like, the rotation direction is reversed so that the elliptically-polarized light rotating left becomes elliptically-polarized light rotating right (or elliptically-polarized light rotating left). Thereafter, when the elliptically-polarized light rotating right (or the elliptically-polarized light rotating left) made by reversing the rotation direction again transmits through the liquid crystal layer in the reflective display area, the elliptically-polarized light rotating right becomes linearly-polarized light (for example, linearly-polarized light in a direction forming 45° in a plan view) vibrating in a direction perpendicular to the transmission axis of the second polarizing plate. Accordingly, this linearly-polarized light is absorbed in the second polarizing plate. In this way, a black display is achieved. On the other hand, when an electric field is not applied to the liquid crystal layer in the reflective display area, the liquid crystal molecules of the liquid crystal layer in the reflective display area are aligned so that the major axis direction is parallel to a direction (for example, a direction forming 135° in a plan view) of the rubbing direction of the alignment film. Therefore, linearly-polarized light (for example, linearly-polarized light in the direction forming 135° in a plan view) which has transmitted through the second polarizing plate transmits through the liquid crystal layer in the reflective display area without reflection, reflects from the reflective layer or the like, and then again transmits through the liquid crystal layer in the reflective display area without reflection. Accordingly, the linearly-polarized light transmits through the second polarizing plate. In this way, a white display is achieved.

Next, the following operation is carried out in the transmissive display area. First, when an electric field is not applied to the liquid crystal layer in the transmissive display area, the liquid crystal molecules of the liquid crystal layer in the transmissive display area are aligned so that the major axis direction is parallel to the direction (for example, the direction forming 135° in a plan view) of the rubbing process of the alignment film. Therefore, linearly-polarized light (for example, linearly-polarizing light in a direction forming 45° in a plan view) which has transmitted through the first polarizing plate and has been incident on the liquid crystal layer in the transmissive display area transmits through the liquid crystal layer in the transmissive display area without reflection, and then is absorbed by the second polarizing plate having the transmission axis perpendicular to the transmission axis of the first polarizing plate. In this way, a black display is achieved. On the other hand, when an electric field is applied to the liquid crystal layer in the transmissive display area, the liquid crystal molecules of the liquid crystal layer in the transmissive display area are influenced under the electric field in the direction (for example, the direction forming 135° in a plan view) perpendicular to the longitudinal direction (for example, the direction forming 45° in a plan view) of the second slit. Therefore, the liquid crystal molecules rotate such that the major axis direction is oriented toward the first direction. Accordingly, the linearly-polarized light (for example, the linearly-polarized light in the direction forming 45° in a plan view) which has transmitted through the first polarizing plate and has been incident on the liquid crystal layer in the transmissive display area becomes rotated light due to distortion of the liquid crystal layer in the transmissive display area, becomes linearly-polarized light (for example, linearly-polarized light in the direction forming 135° in a plan view) in the direction parallel to the transmission axis of the second polarizing plate, and transmits through the second polarizing plate. In this way, a white display is achieved.

The liquid crystal device according to the above aspect of the invention may further include: a first polarizing plate which has a transmission axis oriented in a first direction (for example, a direction forming 45° in a plan view) and is formed on a side of the first substrate opposite to the second substrate; a second polarizing plate which has a transmission axis oriented in a direction (for example, a direction forming 135° in a plan view) perpendicular to the first direction and is formed on the side of the second substrate opposite to the first polarizing plate; and alignment films which are respectively formed on the sides of the first and second substrates facing the liquid crystal layer and subjected to a rubbing process in the first direction (for example, the direction forming 45° in a plan view) or the direction perpendicular to the first direction. One of the first and second electrodes on the side of the liquid crystal layer has (i) a first slit extending in a direction (for example, a direction forming 0° in a plan view) forming 45° with respect to the first direction in the reflective display area and (ii) a second slit extending in the direction (for example, the direction forming 0° in a plan view) forming 45° with respect to the first direction in the transmissive display area. Retardation of the liquid crystal layer in the reflective display area is a ¼ wavelength and retardation of the liquid crystal layer in the transmissive display area is a ½ wavelength.

According to the above aspect of the invention, the following operation is carried out in the reflective display area. First, when an electric field is applied to the liquid crystal layer in the reflective display area, the liquid crystal molecules of the liquid crystal layer in the reflective display area rotate by the electric field generated in the direction (for example, the direction forming 90° in a plan view) perpendicular to the longitudinal direction (for example, a direction forming 0° in a plan view) of the first slit such that the major axis direction is oriented toward the longitudinal direction of the first slit. Accordingly, linearly-polarized light (for example, linearly-polarized light vibrating in the direction forming 135° in a plan view) which has transmitted through the second polarizing plate is set such that the retardation of the liquid crystal layer in the reflective display area is a ¼ wavelength. Therefore, when the linearly-polarized light transmits through the liquid crystal layer in the reflective display area, the linearly-polarized light becomes elliptically-polarized light rotating left (or elliptically-polarized light rotating right). Thereafter, when the elliptically-polarized light rotating left (or the elliptically-polarized light rotating right) reflects from the reflective layer or the like, the rotation direction is reversed so that the elliptically-polarized light rotating left becomes elliptically-polarized light rotating right (or elliptically-polarized light rotating left). Thereafter, when the elliptically-polarized light rotating right (or the elliptically-polarized light rotating left) made by reversing the rotation direction again transmits through the liquid crystal layer in the reflective display area, the elliptically-polarized light rotating right becomes linearly-polarized light (for example, linearly-polarized light in the direction forming 45° in a plan view) vibrating in the direction perpendicular to the transmission axis of the second polarizing plate. Accordingly, this linearly-polarized light is absorbed in the second polarizing plate. In this way, a black display is achieved. On the other hand, when an electric field is not applied to the liquid crystal layer in the reflective display area, the liquid crystal molecules of the liquid crystal layer in the reflective display area are aligned so that the major axis direction is parallel to a direction (for example, a direction forming 45° in a plan view) of the rubbing direction of the alignment film. Therefore, linearly-polarized light (for example, linearly-polarized light vibrating in the direction forming 135° in a plan view) which has transmitted through the second polarizing plate transmits through the liquid crystal layer in the reflective display area without reflection, reflects from the reflective layer or the like, and then again transmits through the liquid crystal layer in the reflective display area without reflection. Accordingly, the linearly-polarized light transmits through the second polarizing plate. In this way, the white display is achieved.

Next, the following operation is carried out in the transmissive display area. First, when an electric field is not applied to the liquid crystal layer in the transmissive display area, the liquid crystal molecules of the liquid crystal layer in the transmissive display area are aligned so that the major axis direction is parallel to the direction (for example, the direction forming 45° in a plan view) of the rubbing process of the alignment film. Therefore, linearly-polarized light (for example, linearly-polarizing light in a direction forming 45° in a plan view) which has transmitted through the first polarizing plate and has been incident on the liquid crystal layer in the transmissive display area transmits through the liquid crystal layer in the transmissive display area without reflection, and then is absorbed by the second polarizing plate having the transmission axis perpendicular to the transmission axis of the first polarizing plate. In this way, a black display is achieved. On the other hand, when an electric field is applied to the liquid crystal layer in the transmissive display area, the liquid crystal molecules of the liquid crystal layer in the transmissive display area rotate by the electric field generated in the direction (for example, the direction forming 90° in a plan view) perpendicular to the longitudinal direction (for example, the direction forming 0° in a plan view) of the second slit such that the major axis direction is oriented toward the longitudinal direction of the slit. Accordingly, when the linearly-polarized light (for example, the linearly-polarized light in the direction forming 45° in a plan view) which has transmitted through the first polarizing plate and has been incident on the liquid crystal layer in the transmissive display area transmits through the liquid crystal layer in the transmissive display area, the linearly-polarized light becomes elliptically-polarized light. Thereafter, the elliptically-polarized light is incident on the second polarizing plate, but a component of the linearly-polarized light (for example, a component of the linearly-polarized light in the direction forming 135° in a plan view) in the direction parallel to the transmission axis of the second polarizing plate in the elliptically-polarized light transmits through the second polarizing plate. In this way, the white display is achieved.

Here, since the liquid crystal molecules rotate in the direction forming 45° or 135° with respect to the transmission axis of the first polarizing plate and the retardation of the liquid crystal layer is set to the ½ wavelength, most of the elliptically-polarized light having transmitted through the liquid crystal layer can become a component of the linearly-polarized light in the direction parallel to the transmission axis of the second polarizing plate. Therefore, the transmissivity of light can be improved relatively. As a result, it is possible to achieve a relatively bright white display.

In particular, according to the above aspect of the invention, since the liquid crystal layer contains the liquid crystal molecules having a negative dielectric anisotropy, the liquid crystal molecules are not erected or do not rise up in the direction perpendicular to the surface of the first or second substrate. Accordingly, since the retardation of the liquid crystal layer can be surely set to the ½ wavelength, it is possible to achieve a relatively bright white display.

In the liquid crystal device according to the above aspect of the invention in which one of the first and second electrodes includes the first and second slits, the second electrode may include a second electrode for reflective display of the reflective display area and a second electrode for transmissive display of the transmissive display area. Moreover, the liquid crystal device may further include a voltage applying circuit which applies a voltage to the first electrode so that the polarity of a voltage applied to the second electrode for reflective display and the polarity of a voltage applied to the second electrode for transmissive display are reversed to each other.

According to the above aspect of the invention, it is possible to realize a state where a voltage is applied to the transmissive display area at a time when the voltage is not being applied to the reflective display area, and the voltage is not applied to the transmissive display area at a time when the voltage is being applied to the reflective display area. Accordingly, when the voltage is not applied to the reflective display area and the voltage is applied to the transmissive display area, as described above, the liquid crystal device can achieve the white display as a whole. Likewise, when the voltage is applied to the reflective display area and the voltage is not applied to the transmissive display area, the liquid crystal device can achieve the black display as a whole. As a result, it is possible to appropriately operate the liquid crystal device.

In this case, since a potential difference occurs between the second electrode for reflective display and the second electrode for transmissive display, the electric field is generated therebetween. However, since the liquid crystal molecules have a negative dielectric anisotropy, it is possible to prevent contrast or transmissivity from deteriorating due to the liquid crystal molecules erected in the vicinity of the boundary between the reflective display area and the transmissive display area. Accordingly, since sufficient contrast or transmissivity can be obtained even though a space between the transmissive display area and the reflective display area is not made broader, it is possible to improve an aperture ratio and the transmissivity.

In the liquid crystal device according to the above aspect of the invention, the first electrode may be a pixel electrode and the second electrode may be a common electrode.

According to the above aspect of the invention, the common electrode is divided into the electrode for reflective display and the electrode for transmissive display and the pixel electrode is common, it is possible to apply another voltage to the liquid crystal layer in the reflective display area and the transmissive display area without increasing the number of data lines for transmitting data to the pixel electrode.

### Electronic Apparatus

According to another aspect of the invention, there is provided an electronic apparatus including the liquid crystal device described above.

Since the electronic apparatus according to this aspect of the invention includes the above-described liquid crystal device according to the above aspect of the invention, it is possible to appropriately prevent burn-in from occurring. Accordingly, there can be realized various electronic apparatuses such as a projection type display apparatus, a television, a portable telephone, an electronic pocket book, a portable audio player, a word processor, a digital camera, a view finder type or monitor direct view-type video tape recorder, a workstation, a television phone, a POS terminal, and a touch panel capable of preventing burn-in from occurring.

Operations and other advantages of the invention are apparent from an embodiment described below.

### BRIEF DESCRIPTION OF THE DRAWINGS

The invention will be described with reference to the accompanying drawings, wherein like numbers reference like elements.

FIG. 1 is a top view illustrating the configuration of a liquid crystal device according to an embodiment.

FIG. 2 is a sectional view taken along the line I-I of FIG. 1.

FIG. 3 is a block diagram conceptually illustrating the electric configuration of major units of the liquid crystal device according to the embodiment.

FIG. 4 is a top view conceptually illustrating the detailed configuration of a pixel.

FIGS. 5A and 5B are sectional views conceptually illustrating the drive state of the liquid crystal device according to the embodiment.

FIGS. 6A and 6B are sectional views conceptually illustrating the drive state of a liquid crystal device according to a comparative example.

FIG. 7 is a top view conceptually illustrating the detailed configuration of a pixel of a liquid crystal device according to a modified example.

FIG. 8 is a perspective view illustrating a mobile personal computer to which the liquid crystal device is applied.

FIG. 9 is a perspective view illustrating a portable telephone to which the liquid crystal device is applied.

### DESCRIPTION OF EXEMPLARY EMBODIMENT

Hereinafter, an exemplary embodiment of the invention will be described with reference to the drawings.

### 1. Basic Configuration of Liquid Crystal Device

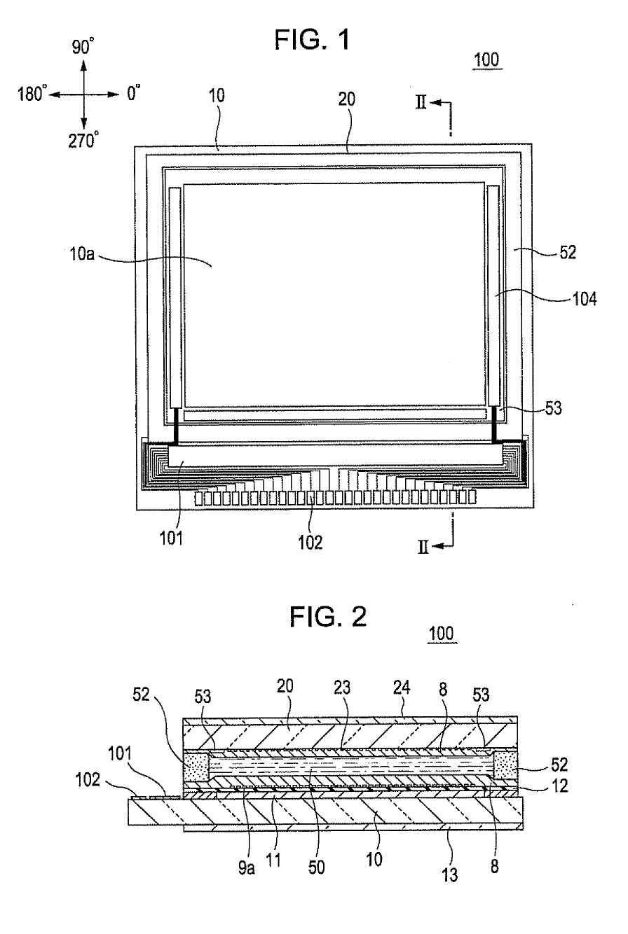

First, the configuration of a liquid crystal device according to this embodiment will be described with reference to FIGS. 1 and 2. FIG. 1 is a top view illustrating the configuration of the liquid crystal device according to this embodiment. FIG. 2 is a sectional view taken along the line II-II of FIG. 1.

In FIGS. 1 and 2, in the liquid crystal device according to this embodiment, a TFT array substrate 10, which is an example of “a first substrate” according to the invention, and a counter substrate 20, which is an example of “a second substrate” according to the invention, are disposed so as to be opposed to each other. A liquid crystal layer 50 is sealed between the TFT array substrate 10 and the counter substrate 20. The TFT array substrate 10 and the counter substrate 20 are attached to each other by a sealing member 52 which is provided in a sealing area being located in the periphery of an image display area 10a and having a casing shape or a frame shape.

The sealing member 52 is formed of an ultraviolet curable resin or a thermoset resin, for example, to attach both the substrates. In a manufacturing process, the sealing member 52 is applied on the TFT array substrate 10, and then hardened by ultraviolet radiation, heating, or the like. In the sealing member 52, spacers such as fiberglass or glass beads are dispersed for maintaining a predetermined gap (a gap between the substrates) between the TFT array substrate 10 and the counter substrate 20.

The counter substrate 20 is provided with a frame light-shielding film 53, which has a light-shielding property, is parallel to the inside of the sealing area provided with the sealing member 52, and defines the frame area of an image display area 10a. In an area located outside the sealing area provided with the sealing member 52 in the peripheral area, a data line driving circuit 101 and external circuit connection terminals 102 are disposed along one side of the TFT array substrate 10. Alternatively, the data line driving circuit 101 may be disposed in an area inside the sealing area so that the data line driving circuit 101 is covered with the frame light-shielding film 53. Scanning line driving circuits 104 are respectively disposed inside the sealing area along two sides adjacent to the above side so as to be covered with the frame light-shielding film 53.

In FIG. 2, a laminated configuration having pixel switching TFTs (Thin Film Transistors) 116 as driving elements and wirings such as scanning lines Y1 to Yn (where n is an integer equal to or larger than 1) and data lines X1 to Xm (where m is an integer equal to or larger than 1) is formed on the TFT array substrate 10. Specifically, in the image display area 10a, a common electrode 11, an insulating layer 12, and pixel electrodes 9a are formed in this order on the pixel switching TFTs 116 or the wirings such as the scanning lines Y1 to Yn and the data lines X1 to Xm. That is, the liquid crystal device 100 according to this embodiment uses a transverse electric field driving mode (particularly, an FFS mode) for controlling an alignment state of the liquid crystal layer 50 by an electric field to be generated between the pixel electrodes 9a and the common electrode 11.

A polarizing plate 13 as a specific example of “a first polarizing plate” of the invention is laminated on the surface of the TFT array substrate 10 opposite to the liquid crystal layer 50. Likewise, a polarizing plate 24 as a specific example of “a second polarizing plate” of the invention is laminated on the surface of the counter substrate 20 opposite to the liquid crystal layer 50. Here, it is preferable that the direction of the transmission axis of the polarizing plate 13 is perpendicular to the direction of the transmission axis of the polarizing plate 24. For example, it is preferable that the direction of the transmission axis of the polarizing plate 13 is 45° (hereinafter, see angles shown in FIG. 1) in a plan view and the direction of the transmission axis of the polarizing plate 24 is 135° in a plan view.

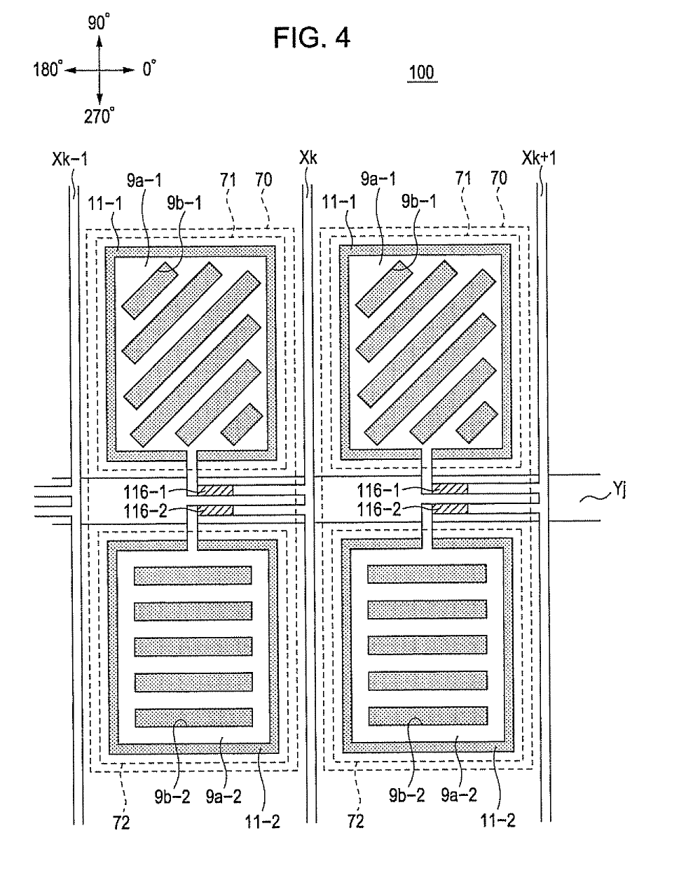

Here, the pixel electrodes 9a, which is a specific example of one of “a first electrode” and “a second electrode” of the invention, are formed in a matrix shape in a plan view so as to form pixels constituting the image display area 10a. The pixel electrodes 9a each have a slit 9b extending in a longitudinal direction thereof, as described below (see FIG. 4). On the other hand, the common electrode 11 as a specific example of one of “the first electrode” and “the second electrode” of the invention may be formed in a matrix shape in a plan view like the pixel electrodes 9a or may be formed in a solid shape in a plan view so as to be common to the plurality of pixel electrodes 9a.

An alignment film 8 is laminated on the pixel electrode 9a (in other words, on the TFT array substrate 10 in which constituent elements such as the pixel electrodes 9a are formed). On the other hand, a color filter (not shown) and a black matrix 23 are formed on the surface of the counter substrate 20 faced the TFT array substrate 10. The black matrix 23 is formed of a lightshielding metal film such as chrome or chromium oxide and patterned in a lattice shape, for example, within the image display area 10a on the counter substrate 20. In addition, the alignment film 8 is formed on the black matrix 23. At this time, the alignment films 8 each formed on the TFT array substrate 10 and the counter substrate 20 are subjected to a rubbing process. It is preferable that a rubbing direction is the direction of the transmission axis of the polarizing plate 13 or the direction of the transmission direction of the polarizing plate 24. It is preferable that the rubbing direction of the TFT array substrate 10 is opposite to the rubbing direction of the counter substrate 20 in consideration of a pretilt angle of liquid crystal molecules. For example, it is preferable that the rubbing direction is at 135° which is the direction of the transmission axis of the polarizing plate 24 (or a direction oriented in a plan view at 45° which is the direction of the transmission axis of the polarizing plate 13).

The liquid crystal layer 50 contains liquid crystal molecules 50a formed by mixing one or various kinds of nematic liquid crystal, for example, and takes a predetermined alignment state between the pair of alignment films 8. In this embodiment, particularly, the liquid crystal molecules 50a contained in the liquid crystal layer 50 have a negative dielectric anisotropy. Specifically, the dielectric anisotropy As Δε the liquid crystal molecules 50a contained in the liquid crystal layer 50 is −4. However, the dielectric anisotropy Δε of the liquid crystal molecules 50a contained in the liquid crystal layer 50 may be a value other than −4. In addition, a birefringence Δn of the liquid crystal molecules 50a contained in the liquid crystal layer 50 is 0.1, but may be a value other than 0.1.

Even though not shown here, an inspection circuit, an inspection pattern, or the like for inspecting the quality of a liquid crystal device or a defect during manufacture or in shipment may be formed on the TFT array substrate 10, as well as the data line driving circuit 101 and the scanning line driving circuits 104.

### 2. Detailed Configuration of Liquid Crystal Device

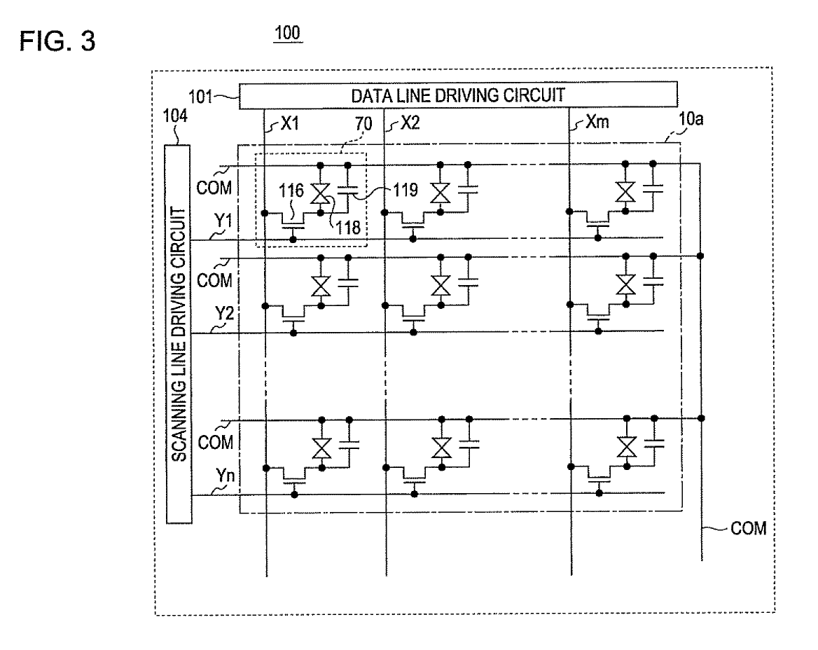

Next, the electric configuration of the major units of the liquid crystal device 100 according to this embodiment will be described with reference to FIGS. 3 and 4. Here, FIG. 3 is a block diagram conceptually illustrating the electric configuration of the major units of the liquid crystal device 100 according to this embodiment. FIG. 4 is a top view conceptually illustrating the detailed configuration of the pixel 70.

In the liquid crystal device 100 shown in FIG. 3, the scanning line driving circuit 104, the data line driving circuit 101, and a driving circuit such as a driver IC circuit (not shown) are formed in a peripheral area around the image display area 10a on the TFT array substrate 10.

The scanning line driving circuit 104 sequentially supplies a scanning signal to the scanning lines Y1 to Yn. For example, when a high-level scanning signal is supplied to a scanning line Yj (where j is an integer satisfying a relation of 1≦j≦n), all the TFTs 116 connected to the scanning line Yj are turned on and all the pixels 70 corresponding to the scanning line Yj are selected.

The data line driving circuit 101 sequentially supplies an image signal to the data lines X1 to Xm and writes a writing voltage based on the image signal to the pixel electrodes 9a through the turned-on TFTs 116.

In the liquid crystal device 100 according to this embodiment, the plurality of pixels 70 arranged in the matrix shape is disposed in the image display area 10a located in the middle of the TFT array substrate 10.

As shown in FIGS. 3 and 4, the pixel 70 has a substantially rectangular shape in a plan view and includes the pixel electrode 9a having a plurality of slits 9b formed therein, the common electrode 11 having a solid shape containing the pixel electrode 9a in a plan view, a data line Xk (where k is an integer satisfying a relation of 1≦k≦m) extending along the longer side of the pixel electrode 9a, the scanning line Yj (where j is an integer satisfying the relation of 1≦j≦n) extending along the shorter side of the pixel electrode 9a, the pixel switching TFT 116 formed in the vicinity of the intersection of the data line Xk and the scanning line Yj, and a storage capacitor 119 (which is not shown in FIG. 4).

As for the TFT 116, a source terminal thereof is electrically connected to one of the data lines X1 to Xm, a gate terminal thereof is electrically connected to one of the scanning lines Y1 to Yn, and a drain terminal thereof is electrically connected to the pixel electrode 9a. The pixel switching TFT 116 switches between an ON state and an OFF state in accordance with a scanning signal supplied from the scanning line driving circuit 104.

A liquid crystal element 118 includes the pixel electrode 9a, the common electrode 11, and the liquid crystal molecules 50a located between the pixel electrode 9a and the common electrode 11. The pixel electrode 9a is electrically connected to one of the data lines X1 to Xm through the TFT 116. The common electrode 11 is electrically connected to a common wiring COM. As described above, the pixel electrode 9a and the common electrode 11 are disposed on the TFT array substrate 10. In an operation of the liquid crystal device 100, an electric field is generated between the pixel electrode 9a having a potential (writing potential) of the image signal supplied through the data lines X1 to Xm and the TFT 116 and the common electrode 11 having a common potential supplied through the common wiring COM. A gray scale display is achieved by driving the liquid crystal in accordance with the electric field, that is, varying the alignment or order of the liquid crystal molecules in accordance with the electric field and modulating light.

The storage capacitor 119 is added parallel to the liquid crystal element 118 to prevent the held image signal from leaking. One electrode of the storage capacitor 119 is electrically connected to the pixel electrode 9a and the other electrode thereof is electrically connected to the common electrode 11.

In particular, in this embodiment, the pixel 70 is provided with a transmissive display area 71 for transmissive display and a reflective display area 72 for reflective display. That is, the liquid crystal device 100 according to this embodiment is a transflective liquid crystal device.

In the transmissive display area 71, a slit 9b-1 is formed and a pixel electrode 9a-1 as a transparent electrode is formed as the above-described pixel electrode 9a. Here, it is preferable that the slit 9b-1 in the transmissive display area 71 is formed so that the longitudinal direction thereof is substantially perpendicular to the rubbing direction of the alignment film 8. Specifically, since the rotation direction of the liquid crystal molecules by the electric field may not be uniform when the longitudinal direction thereof is completely perpendicular to the rubbing direction, it is preferable that the longitudinal direction is oriented at an angle from about 5° to about 15° with respect to the direction perpendicular to the rubbing direction. More specifically, for example, it is preferable that the slit 9b-1 is formed so that the longitudinal direction thereof is oriented at an angle of 45°±50 in a plan view. In FIG. 4, the slit 9b-1 is formed as a rectangular opening. However, the shape of the slit 9b-1 is not limited to the rectangular shape of the opening formed in the pixel electrode 9a-1. For example, the slit 9b-1 may be formed as an opening having an arbitrary shape. In addition, the slit 9b-1 is not limited to the opening disposed in the pixel electrode 9a. For example, the slit 9b-1 may have a shape of which one side is open (that is, the pixel electrode 9a-1 may have a pectinate shape). In the transmissive display area 71, a common electrode 11-1 as a transparent electrode is formed as the above-described common electrode 11. In addition, in the transmissive display area 71, a TFT 161-1 of which the drain terminal is electrically connected to the pixel electrode 9a-1 is formed as the above-described TFT 161 (that is, a switching element for the transmissive display area 71). It is preferable that the retardation of the liquid crystal layer 50 in the transmissive display area 71 is set to λ/2 (that is, a ½ wavelength). However, the retardation may be set to a value other than λ/2. A cell gap of the liquid crystal layer 50 in the transmissive display area 71 is 3 μm, but may be a value other than 3 μm.

In the reflective display area 72, a slit 9b-2 is formed and a pixel electrode 9a-2 as a transparent electrode is formed as the above-described pixel electrode 9a. Here, it is preferable that the slit 9b-2 in the reflective display area 72 is formed so that the longitudinal direction thereof is oriented at an angle of 45° with respect to the direction of the transmission axis of the polarizing plate 13. Specifically, for example, it is preferable that the slit 9b-2 is formed so that the longitudinal direction thereof is oriented at an angle of 0° in a plan view. In FIG. 4, the slit 9b-2 is formed as a rectangular opening. However, the shape of the slit 9b-2 is not limited to the opening having rectangular shape formed in the pixel electrode 9a-2. For example, the slit 9b-2 may be formed as an opening having an arbitrary shape. In addition, the slit 9b-2 is not limited to the opening disposed in the pixel electrode 9a. For example, the slit 9b-2 may have a shape of which one side is open (that is, the pixel electrode 9a-2 may have a pectinate shape). In the reflective display area 72, a common electrode 11-2 as a metal electrode containing a metal material is formed as the above-described common electrode 11. The common electrode 11-2 functions as a reflective layer reflecting external light incident from the counter substrate 20. Instead of configuring the common electrode 11-2 as the metal electrode, a reflective layer containing a metal material may be separately provided. In addition, in the reflective display area 72, a TFT 161-2 of which the drain terminal is electrically connected to the pixel electrode 9a-2 is formed as the above-described TFT 161 (that is, a switching element for the reflective display area 72). It is preferable that the retardation of the liquid crystal layer 50 in the reflective display area 72 is set to λ/4 (that is, a ¼ wavelength). However, the retardation may be set to a value other than λ/4. A cell gap of the liquid crystal layer 50 in the reflective display area 72 is 1.5 μm, but may be a value other than 1.5 μm.

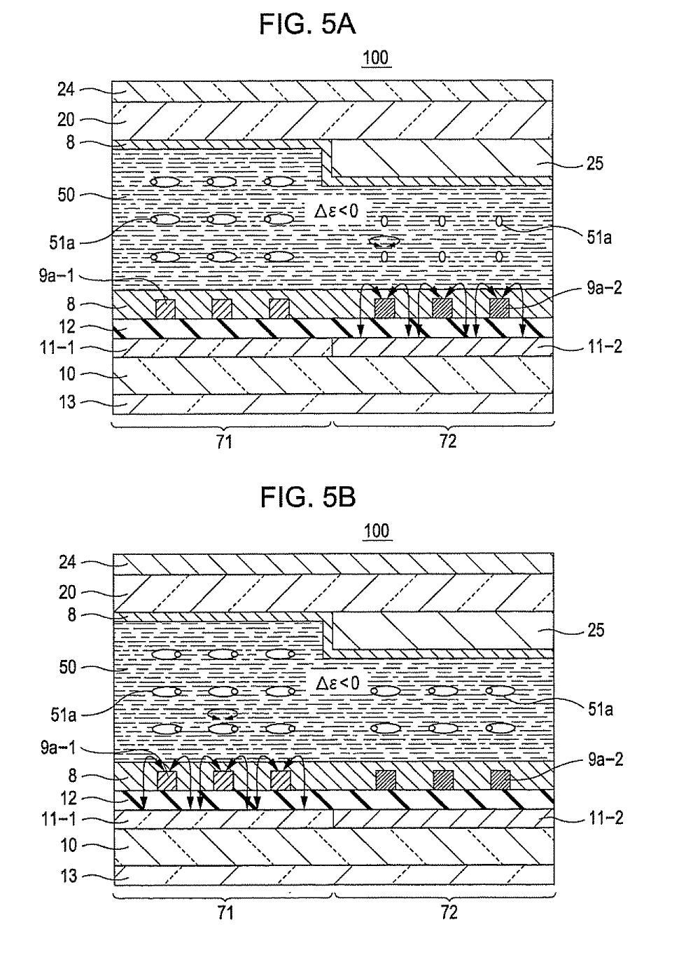

The cell gap of the liquid crystal layer 50 in the transmissive display area 71 is different from the cell gap of the liquid crystal layer 50 in the reflective display area 72. This difference is realized by forming a bump portion 25 (see FIG. 5 or the like) on the counter substrate 20 in the reflective display area 72.

### 3. Drive of Liquid Crystal Device

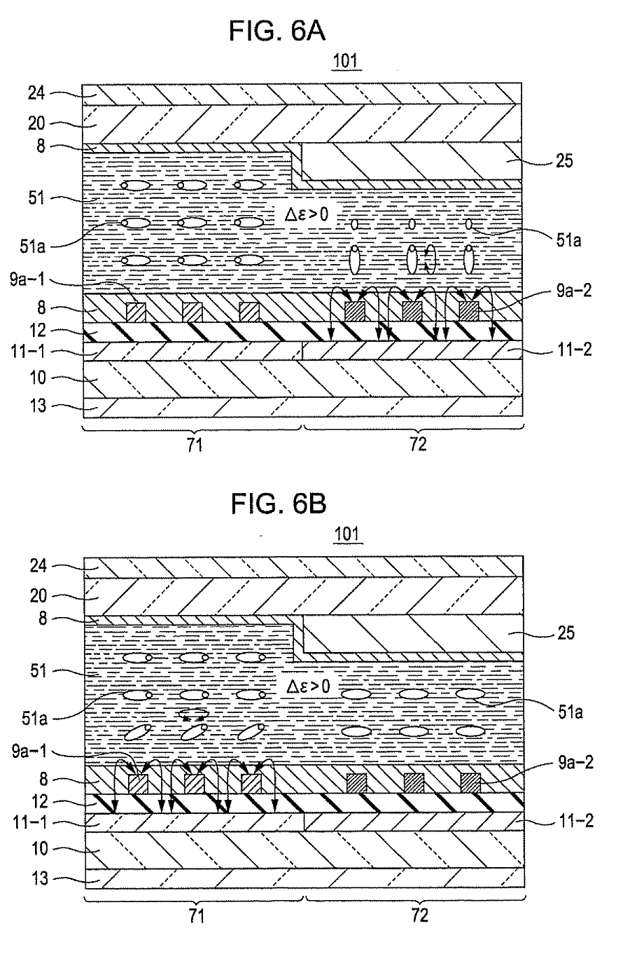

Next, the drive of the liquid crystal device 100 will be described with reference to FIGS. 5A and 5B and FIGS. 6A and 6B. Here, FIGS. 5A and 5B are sectional views conceptually illustrating the drive state of the liquid crystal device 100 according to this embodiment. FIGS. 6A and 6B are sectional views conceptually illustrating the drive state of a liquid crystal device 101 according to a comparative example.

The liquid crystal device 100 according to this embodiment is operated in the following manner. First, by allowing the scanning line driving circuit 104 to supply the high-level scanning signal to the scanning line Yj, all the TFTS 116 connected to the scanning line Yj are turned on so as to select all the pixels 70 associated with the scanning line Yj. In synchronization with the selection of the pixels 70 associated with the scanning line Yj, the data line driving circuit 101 supplies the image signal to the data lines X1 to Xm. In this way, the image is supplied from the data line driving circuit 101 to all the pixels 70 selected by the scanning line driving circuit 104 through the data lines X1 to Xm and the TFTS 116, and then the writing voltage based on the image signal is written to the pixel electrodes 9a. Accordingly, a potential difference occurs between the pixel electrode 9a and the common electrode 11 and a driving voltage is applied to the liquid crystal.

At this time, it is preferable that a common potential is supplied to the common wiring COM so that the polarity of the voltage to be supplied to the common electrode 11-1 of the transmissive display area 71 is reverse to the polarity of the voltage to be supplied to the common electrode 11-2 of the reflective display area 72. In this case, when low voltage is supplied to the pixel electrodes 9a-1 and 9a-2, the electric field is not applied to the liquid crystal layer 50 in the transmissive display area 71, but the electric field is applied to the liquid crystal layer 50 in the reflective display area 72.

Hereinafter, the drive of the liquid crystal device 100 will be described in more detail in order of the transmissive display area 71 and the reflective display area 72.

First, the drive state in the transmissive display area 71 will be described. When the potential difference between the pixel electrodes 9a and the common electrode 11 is zero, as shown in FIG. 5A, the liquid crystal molecules 50a contained in the liquid crystal layer 50 is aligned in an initial state. Specifically, the major axis direction of the liquid crystal molecules 50a is maintained so as to be aligned in the rubbing direction of the alignment film 8. In addition, the major axis direction of the liquid crystal molecules 50a is maintained so as to be aligned substantially parallel to the surface of the TFT array substrate 10 (that is, the major axis direction of the liquid crystal molecules 50a is aligned in the direction forming 135° in a plan view). At this time, light emitted from a backlight unit is incident on the polarizing plate 13 from the TFT array substrate 10. In this case, only the component of the linearly-polarized light vibrating in the direction forming 45° in a plan view in the light incident from the backlight unit is incident on the liquid crystal device 100 due to the presence of the polarizing plate 13. Thereafter, since the alignment of the liquid crystal molecules 50a are maintained in the initial state, the linearly-polarized light vibrating in the direction forming 45° in a plan view transmits through the liquid crystal layer 50 without reflection. Here, since the transmission axis of the polarizing plate 24 of the counter substrate 20 is 135° in a plan view, the component of the linearly-polarized light vibrating in the direction forming 45° in a plan view is absorbed by the polarizing plate 24. As a consequence, the light from the backlight unit is not emitted outside the liquid crystal device 100. In this way, a black display is achieved in the liquid crystal device 100.

Alternatively, when the potential difference between the pixel electrodes 9a and the common electrode 11 is not zero, the liquid crystal device 100 is driven in the following manner. When the potential difference between the pixel electrodes 9a and the common electrode 11 is not zero, as shown in FIG. 5B, the electric field (see a bold line arrow in FIG. 5B) in a direction parallel or substantially parallel to the TFT array substrate 10 is generated between the pixel electrodes 9a and the common electrode 11. Therefore, the electric field in the direction parallel or substantially parallel to the TFT array substrate 10 is applied to the liquid crystal layer 50. As a consequence, since the liquid crystal molecules 50a contained in the liquid crystal layer 50 are in the plane parallel to the surface of the TFT array substrate 10 and influenced under the electric field in a direction (for example, a direction forming 135° in a plan view) perpendicular to the longitudinal direction of the slit 9b-1, the major axis direction of the liquid crystal molecules 50a rotate in the longitudinal direction of the slit 9b-1. At this time, the light from the backlight unit is incident on the polarizing plate 13 from the TFT array substrate 10. In this case, only the component of the linearly-polarized light vibrating in the direction forming 45° in a plan view in the light incident from the backlight unit is incident on the liquid crystal device 100 due to the presence of the polarizing plate 13. Thereafter, the component of the linearly-polarized light vibrating in the direction forming 45° in a plan view is incident on the liquid crystal layer 50. However, since the retardation of the liquid crystal layer 50 is λ/2, the component of the linearly-polarized light becomes rotated light due to distortion of the liquid crystal layer 50 and becomes elliptically-polarized light occupied mostly by the component of the linearly-polarized light vibrating in the direction forming 135° in a plan view. Thereafter, only the linearly-polarized light vibrating in the direction of the transmission axis of the polarizing plate 24 (that is, the linearly-polarized light vibrating in the direction forming 135° in a plan view) in the elliptically-polarized light transmitting through the liquid crystal layer 50 is emitted outside the liquid crystal device 100. In this way, a white display is achieved in the liquid crystal device 100.

Next, the drive state in the reflective display area 72 will be described. When the potential difference between the pixel electrodes 9a and the common electrode 11 is not zero, the liquid crystal device 100 is driven in the following manner. When the potential difference between the pixel electrodes 9a and the common electrode 11 is not zero, as shown in FIG. 5A, the electric field (see a bold line arrow in FIG. 5A) in a direction parallel or substantially parallel to the TFT array substrate 10 is generated between the pixel electrodes 9a and the common electrode 11. Therefore, the electric field in the direction parallel or substantially parallel to the TFT array substrate 10 is applied to the liquid crystal layer 50. As a consequence, the liquid crystal molecules 50a contained in the liquid crystal layer 50 are in the plane parallel to the surface of the TFT array substrate 10. The liquid crystal molecules 50a rotate so that the major axis direction thereof is oriented in the longitudinal direction of the slit 9b-2 by the electric field perpendicular to the longitudinal direction of the slit 9b-2. At this time, external light is incident on the polarizing plate 24 from the counter substrate 20. In this case, only the component of linearly-polarized light vibrating in the direction forming 135° in a plan view in the incident external light is incident on the liquid crystal device 100 due to the presence of the polarizing plate 24. Thereafter, the component of the linearly-polarized light vibrating in the direction forming 135° in a plan view is incident on the liquid crystal layer 50. However, since the retardation of the liquid crystal layer 50 is λ/4, the component of the linearly-polarized light becomes elliptically-polarized light rotating right (or elliptically-polarized light rotating left) by transmitting the component of the linearly-polarized light through the liquid crystal layer 50. Thereafter, elliptically-polarized light rotating right (or the elliptically-polarized light rotating left) is reflected from the common electrode 11-2 and thus becomes elliptically-polarized light rotating left (or elliptically-polarized light rotating right) of which the rotation direction is reversed. Thereafter, the elliptically-polarized light rotating left (or the elliptically-polarized light rotating right) of which the rotation direction is reversed is again incident on the liquid crystal layer 50, but the component of the elliptically-polarized light transmits through the liquid crystal layer 50 and thus becomes linearly-polarized light vibrating in the direction forming 45° in a plan view. Here, since the transmission axis of the polarizing plate 24 of the counter substrate 20 is 135° in a plan view, the component of the linearly-polarized light vibrating in the direction forming 45° in a plan view is absorbed by the polarizing plate 24. As a consequence, the light from the backlight unit is not emitted outside the liquid crystal device 100. In this way, the black display is achieved in the liquid crystal device 100.

Alternatively, when the potential difference between the pixel electrodes 9a and the common electrode 11 is zero, the liquid crystal device 100 is driven in the following manner. When the potential difference between the pixel electrodes 9a and the common electrode 11 is zero, the liquid crystal molecules 50a contained in the liquid crystal layer 50 are aligned in the initial state. Specifically, the major axis direction of the liquid crystal molecules 50a is aligned with the rubbing direction of the alignment film 8 and the major axis direction of the liquid crystal molecules 50a is substantially parallel to the surface of the TFT array substrate 10 (that is, the major axis direction of the liquid crystal molecules 50a is aligned with the direction forming 135° in a plan view). At this time, external light or the like is incident on the polarizing plate 24 from the counter substrate 20. In this case, only the component of the linearly-polarized light vibrating in the direction forming 135° in a plan view in the incident external light is incident on the liquid crystal device 100 due to the presence of the polarizing plate 24. Thereafter, the component of the linearly-polarized light vibrating in the direction forming 135° in a plan view is incident to the liquid crystal layer 50. However, the component of the linearly-polarized light transmits through the liquid crystal layer 50 without reflection, reflects from the common electrode 11-2, and again transmits through the liquid crystal layer 50 without reflection. Therefore, the linearly-polarized light (that is, the component of the linearly-polarized light vibrating in the direction forming 135° in a plan view) transmits the polarizing plate 24. In this way, the white display is achieved in the liquid crystal device 100.

Here, since the liquid crystal molecules 50a have a negative dielectric anisotropy, the liquid crystal molecules 50a rotate with the application of the electric field so that the major axis direction of the liquid crystal molecules 50a is perpendicular to the application direction of the electric field. In other words, the liquid crystal molecules 50a rotate so that the minor axis direction of the liquid crystal molecules 50a is oriented toward the application direction of the electric field. Therefore, when a horizontal electric field, which is an electric field in the direction of the surface of the TFT array substrate 10, is applied, the major axis direction of the liquid crystal molecules 50a rotates in the plane parallel to the surface of the TFT array substrate 10. On the other hand, even when a vertical electric field which is an electric field (typically, an electric field perpendicular or substantially perpendicular to the surface of the TFT array substrate 10) with a direction intersecting the surface of the TFT array substrate 10 is unintentionally applied to the liquid crystal layer 50, the minor axis of the liquid crystal molecules 50a is aligned in the direction of the vertical electric field (that is, the major axis direction of the liquid crystal molecules 50a is perpendicular to the vertical electric field). Therefore, the liquid crystal molecules 50a are aligned so that the major axis direction of the liquid crystal molecules 50a is parallel to the surface of the TFT array substrate 10. That is, even when the vertical electric field is unintentionally applied to the liquid crystal layer 50 as well as the horizontal electric field which is originally applied to the liquid crystal layer 50, the major axis direction of the liquid crystal molecules 50a is surely parallel to the surface of the TFT array substrate 10 along the vertical electric field and the liquid crystal molecules 50a rotate along the horizontal electric field in the plane parallel to the surface of the TFT array substrate 10. Therefore, even when the vertical electric field is applied as well as the horizontal electric field, the liquid crystal molecules 50a rotate while maintaining the state where the major axis direction thereof is substantially parallel to the surface of the TFT array substrate 10.

on the other hand, in the liquid crystal device 101 which includes a liquid crystal layer 51 containing liquid crystal molecules 51a having a positive dielectric anisotropy according to the comparative example, the liquid crystal molecules 51a rotate so that the major axis direction thereof is erected with respect to the TFT array substrate 10 when the vertical electric field as an electric field in the direction intersecting the surface of the TFT array substrate 10 is unintentionally applied to the liquid crystal layer 51, as show in FIGS. 6A and 6B. In other words, the liquid crystal molecules 51a rotate such that the major axis direction thereof is inclined in the direction perpendicular to the surface of the TFT array substrate 10. Therefore, the alignment of the liquid crystal molecules 51a is not controlled in an originally intended way, thereby deteriorating the display quality of the liquid crystal device 101.

In this embodiment, however, even when the vertical electric field is applied as well as the horizontal electric field, the liquid crystal molecules 50a rotate while maintaining the state where the major axis direction thereof is substantially parallel to the surface of the TFT array substrate 10. That is, even when the vertical electric field is applied as well as the horizontal electric field, the liquid crystal molecules 50a rarely or never rotate such that the major axis direction of the liquid crystal molecules 50a is erected with respect to the TFT array substrate 10 or inclined in the direction perpendicular to the surface of the TFT array substrate 10. Therefore, the drive of the liquid crystal molecules 50a contained in the liquid crystal layer 50 can be appropriately controlled. Accordingly, since it is possible to appropriately suppress a problem that the black display becomes faint or the white display fades, contrast can be relatively improved. In this way, it is possible to appropriately prevent the display quality of the liquid crystal device 100 from deteriorating.

In particular, the liquid crystal device 100 according to this embodiment is provided with the transmissive display area 71 and the reflective display area 72 in one pixel 70. In such a configuration, the vertical electric field may be unintentionally applied in the vicinity of the boundary between the transmissive display area 71 and the reflective display area 72. Specifically, for example, an electric field generated due to the potential difference between the pixel electrodes 9a and the common electrode 11 within the transmissive display area 71 has to be originally applied to the liquid crystal layer 50 within the transmissive display area 71, and an electric field generated due to the potential difference between the pixel electrodes 9a and the common electrode 11 within the reflective display area 72 has to be originally applied to the liquid crystal layer 50 within the reflective display area 72. However, an electric field generated due to the potential difference between the pixel electrodes 9a within the transmissive display area 71 and the pixel electrodes 9a or the common electrode 11 within the reflective display area 72 or an electric field generated due to the potential difference between the common electrode 11 within the transmissive display area 71 and the pixel electrodes 9a or the common electrode 11 within the reflective display area 72 may be applied to the liquid crystal layer 50. In this case, the electric field generated due to the potential difference between the pixel electrodes 9a within the transmissive display area 71 and the pixel electrodes 9a or the common electrode 11 within the reflective display area 72 or the electric field generated due to the potential difference between the common electrode 11 within the transmissive display area 71 and the pixel electrodes 9a or the common electrode 11 within the reflective display area 72 may become the vertical electric field (or may have the component of the vertical electric field) for the liquid crystal layer 50. However, even when this vertical electric field is generated, as described above, the liquid crystal molecules 50a rotate while maintaining the state where the major axis direction thereof is substantially parallel to the surface of the TFT array substrate 10 or the counter substrate 20. Therefore, even the transflective liquid crystal device 100 can appropriately control the drive of the liquid crystal molecules 50a contained in the liquid crystal layer 50. In particular, the drive of the liquid crystal molecules 50a in the vicinity of the boundary between the transmissive display area 71 and the reflective display area 72 where unstable drive can easily occur can be appropriately controlled. As a result, it is possible to appropriately prevent the display quality of the liquid crystal device 100 from deteriorating.

### 4. Modified Example

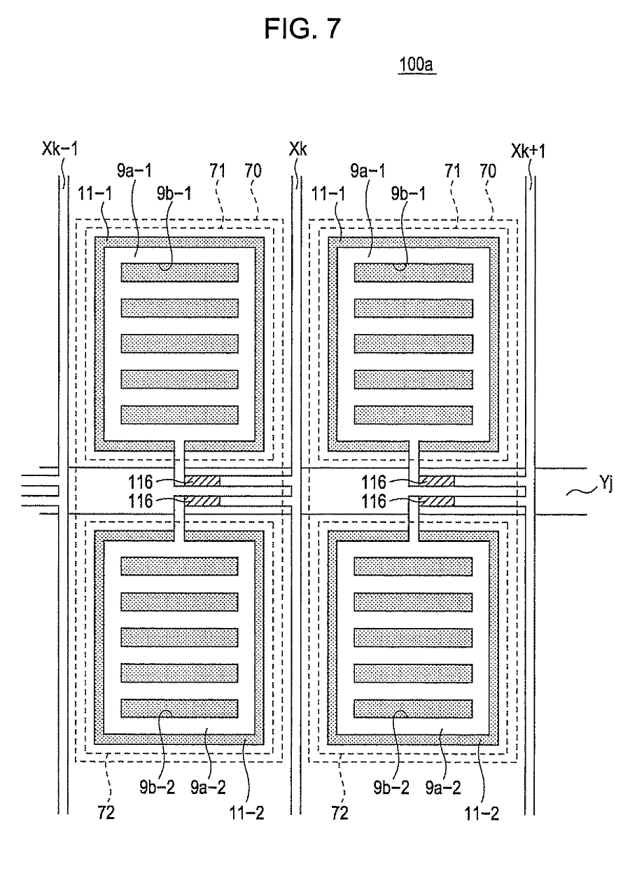

Next, a liquid crystal device 100a according to a modified example will be described with reference to FIG. 7. Here, FIG. 7 is a top view illustrating the configuration of the liquid crystal device 100a according to the modified example. The same reference numerals are given to the same constituent elements as those of the above-described liquid crystal device 100, and a detailed description is omitted.

As shown in FIG. 7, the liquid crystal device 100a according to the modified example has the same configuration as that of the above-described liquid crystal device 100 other than an angle in the direction of the slit 9b-1 included in the pixel electrode 9a-1 in a plan view in the transmissive display area 71. In this case, it is preferable that the rubbing direction of the alignment film 8 is oriented at 45° in a plan view. In particular, in the liquid crystal device 100a according to the modified example, it is preferable that the slit 9b-1 included in the pixel electrode 9a-1 in the transmissive display area 71 is formed such that the longitudinal direction thereof forms 45° with respect to the direction of the transmission axis of the polarizing plate 13. Specifically, for example, it is preferable that the slit 9b-1 is formed such that the longitudinal direction thereof is oriented at 0° in a plan view.

The liquid crystal device 100a having this configuration according to the modified example operates in the following manner.

First, the drive state in the transmissive display area 71 will be described. When the potential difference between the pixel electrodes 9a and the common electrode 11 is zero, the liquid crystal device 100a is driven in the same manner as that of the above-described liquid crystal device 100. Alternatively, when the potential difference between the pixel electrodes 9a and the common electrode 11 is not zero, the liquid crystal molecules 50a contained in the liquid crystal layer 50 are in the plane parallel to the surface of the TFT array substrate 10 and rotate by the electric field in the direction (for example, the direction forming 90° in a plan view) perpendicular to the longitudinal direction of the slit 9b-1 so that the major axis direction of the liquid crystal molecules 50a is oriented in the longitudinal direction of the slit 9b-1. At this time, the light from the backlight unit is incident on the polarizing plate 13 from the TFT array substrate 10. In this case, only the component of the linearly-polarized light vibrating in the direction forming 45° in a plan view in the light incident from the backlight unit is incident on the liquid crystal device 100 due to the presence of the polarizing plate 13. Thereafter, the component of the linearly-polarized light vibrating in the direction forming 45° in a plan view is incident on the liquid crystal layer 50. However, since the retardation of the liquid crystal layer 50 is λ/2, the component of the linearly-polarized light transmits through the liquid crystal layer 50 and thus becomes elliptically-polarized light occupied mostly by the component of the linearly-polarized light vibrating in the direction of the transmission axis of the polarizing plate 24 (that is, the component of the linearly-polarized light vibrating in the direction forming 135° in a plan view). Thereafter, only the component of the linearly-polarized light vibrating in the direction of the transmission axis of the polarizing plate 24 in the elliptically-polarized light which has transmitted through the liquid crystal layer 50 is emitted outside the liquid crystal device 100. In this way, a white display is achieved in the liquid crystal device 100.

Next, the drive state in the reflective display area 72 is the same as that of the above-described liquid crystal device 100.

Accordingly, the liquid crystal device 10a according to the modified example can achieve the various advantages as those of the above-described liquid crystal device 100. In the liquid crystal device 100a according to the modified example, the liquid crystal molecules 50a can rotate so that the major axis direction thereof is oriented to the direction forming 45° or 135° with respect to the transmission axes of the polarizing plates 13 and 24 by setting the longitudinal direction of the slit 9b-l, the rubbing direction of the alignment film 5, and the transmission axis of the polarizing plate 13 (24) to the above-described values. Accordingly, most of the elliptically-polarized light transmitting through the liquid crystal layer 50 can become the component of the linearly-polarized light in the direction parallel to the transmission axis of the polarizing plate 24. In addition, the transmissivity of light (particularly, the transmissivity in the liquid crystal layer 50) can be relatively improved. As a result, a relatively bright white display can be achieved.

### 5. Electronic Apparatus

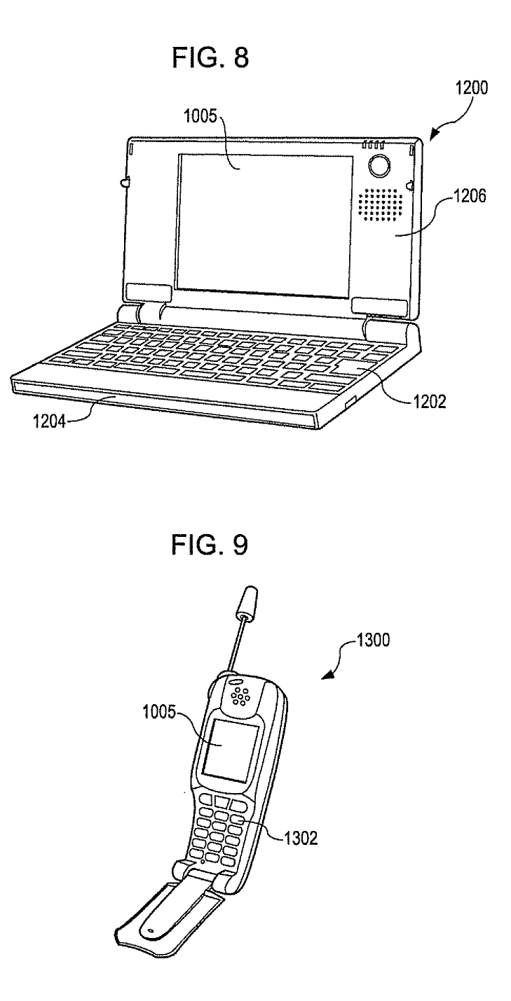

Next, an example of an electronic apparatus including the above-described liquid crystal device 100 will be described with reference to FIGS. 8 and 9.

FIG. 8 is a perspective view illustrating a mobile personal computer to which the above-described liquid crystal device is applied. In FIG. 8, a computer 1200 includes a main body 1204 having a keyboard 1202 and a liquid crystal display unit 1206 having the above-described liquid crystal device 100. The liquid crystal display unit 1206 is provided with a backlight unit on the rear surface of the liquid crystal device 100.

Next, an example in which the above-described liquid crystal device 100 is applied to a portable telephone will be described. FIG. 9 is a perspective view illustrating the portable telephone as an example of an electronic apparatus. In FIG. 9, a portable telephone 1300 includes a plurality of operation buttons 1302 and a liquid crystal device 1005 having the same configuration as that of the above-described liquid crystal device 100.

These electronic apparatuses can achieve the above-described various advantages, since the electronic apparatuses include the above-described liquid crystal device 100.

Examples of the electronic apparatus include a liquid crystal TV, a view finder type or monitor direct view-type video tape recorder, a car navigation apparatus, a pager, an electronic pocket book, a calculator, a word processor, a workstation, a television phone, a POS terminal, and a touch panel, as well as the electronic apparatuses described with reference to FIGS. 8 and 9.

The invention is not limited to the above-described embodiment, but may be appropriately modified in various forms without departing the gist or spirit of the invention in the claims and the specification. Accordingly, the modified liquid crystal device and the modified electronic apparatus are also included in the technical scope of the invention.

The entire disclosure of Japanese Patent Application No. 2008-213639, filed Aug. 22, 2008 is expressly incorporated by reference herein.

What is claimed is:

1. A liquid crystal device comprising:
a plurality of pixels,
wherein each of the plurality of pixels includes a liquid crystal layer interposed between first and second substrates facing each other and having liquid crystal molecules to be driven by an applied electric field, a first electrode formed on a side of the first substrate facing the second substrate, and a second electrode formed on a side of the first substrate facing the second substrate and interposing an insulating layer together with the first electrode,
wherein a reflective display area for reflective display and a transmissive display area for transmissive display are formed within each of the pixels, and
wherein the liquid crystal molecules have a negative dielectric anisotropy.

2. The liquid crystal device according to claim 1, further comprising:
a first polarizing plate which has a transmission axis oriented in a first direction and is formed on a side of the first substrate opposite to the second substrate;
a second polarizing plate which has a transmission axis oriented in a direction perpendicular to the first direction and is formed on a side of the second substrate opposite to the first substrate; and
alignment films which are respectively formed on the sides of the first and second substrates facing the liquid crystal layer and subjected to a rubbing process in the first direction or the direction perpendicular to the first direction,
wherein one of the first and second electrodes on the side of the liquid crystal layer has (i) a first slit extending in a direction forming 45° with respect to the first direction in the reflective display area and (ii) a second slit extending in a direction substantially perpendicular to a rubbing direction in the transmissive display area, and
wherein retardation of the liquid crystal layer in the reflective display area is a ¼ wavelength and retardation of the liquid crystal layer in the transmissive display area is a ½ wavelength.

3. The liquid crystal device according to claim 1, further comprising:
a first polarizing plate which has a transmission axis oriented in a first direction and is formed on a side of the first substrate opposite to the second substrate;
a second polarizing plate which has a transmission axis oriented in a direction perpendicular to the first direction and is formed on a side of the second substrate opposite to the first substrate; and
alignment films which are respectively formed on the sides of the first and second substrates facing the liquid crystal layer and subjected to a rubbing process in the first direction,
wherein one of the first and second electrodes on the side of the liquid crystal layer has (i) a first slit extending in a direction forming 45° with respect to the first direction in the reflective display area and (ii) a second slit extending in the direction forming 45° with respect to the first direction in the transmissive display area, and
wherein retardation of the liquid crystal layer in the reflective display area is a ¼ wavelength and retardation of the liquid crystal layer in the transmissive display area is a ½ wavelength.

4. The liquid crystal device according to claim 2,
wherein the second electrode includes a second electrode for reflective display of the reflective display area and a second electrode for transmissive display of the transmissive display area, and
wherein the liquid crystal device further comprises a voltage applying circuit which applies a voltage to the first electrode so that a polarity of a voltage applied to the second electrode for reflective display and a polarity of a voltage applied to the second electrode for transmissive display are opposite to each other.

5. The liquid crystal device according to claim 4, wherein the first electrode is a pixel electrode and the second electrode is a common electrode.

6. An electronic apparatus comprising the liquid crystal device according to claim 1.
